(19) United States
(12) Patent Application Publication
(10) Pub. No.: US 2021/0056557 A1
(43) Pub. Date: Feb. 25, 2021

(54) METHOD AND SYSTEM FOR VERIFYING POINT OF SALE AUTHENTICITY THROUGH BLOCKCHAIN DISTRIBUTED LEDGER

(71) Applicant: MASTERCARD INTERNATIONAL INCORPORATED, Purchase, NY (US)

(72) Inventors: Prashant SHARMA, Madison, NJ (US); Amy WU, New York, NY (US); Philip Wei Ping YEN, Singapore (SG); Rajat MAHESHWARI, Singapore (SG)

(73) Assignee: MASTERCARD INTERNATIONAL INCORPORATED, Purchase, NY (US)

(21) Appl. No.: 16/545,402

(22) Filed: Aug. 20, 2019

(51) Int. Cl. G06Q 20/42; H04L 9/06; G06Q 20/20; G06Q 20/38

(52) U.S. Cl. CPC G06Q 20/42; G06Q 20/3821; G06Q 20/206; H04L 9/0637

(57) ABSTRACT

A method for verifying the authenticity of a point of sale prior to the initiation of a payment transaction using unique merchant-specific data and blockchain registration includes: receiving identification data from a point of sale device; receiving data comprising a permissioned blockchain, the data including a plurality of blockchain data values, each data value including at least a set of merchant data; verifying the point of sale device by identifying, in the plurality of blockchain data values, a set of merchant data that matches the received identification data; and outputting a notification to a user of the mobile communication device if verification of the point of sale device fails, or transmitting payment credentials stored in the mobile communication device to the point of sale device if verification of the point of sale device is successful.

### FIELD

The present disclosure relates to verifying the authenticity of a point of sale device prior to the initiation of a payment transaction, specifically the use of a blockchain and merchant-specific data to ensure that a point of sale device is genuine before any payment credentials are supplied to the point of sale device.

### BACKGROUND

Traditionally, point of sale devices have been extremely specialized devices that were created to facilitate payment transactions through the receipt of payment credentials and supplying of payment credentials and transaction data to a payment network for processing. These traditional devices were uniquely created to accept payment credentials and communicate with a payment network through its specialized infrastructure. Over time, techniques have been developed that have enabled more standard computing devices, such as a tablet computer or smart phone, to become a point of sale device, such as through additional hardware devices that may be interfaced with the computing device or specially programmed application programs.

However, the development of new point of sale capabilities has happened concurrently with the development of fraudulent devices. Fraudsters have developed spoofed point of sale devices, which look and operate like a genuine point of sale device, but are designed for theft of payment credentials. Skimming devices have also been developed, which attach to point of sale devices to make unauthorized copies of payment credentials when they are read by the point of sale device. Currently, there are no suitable methods for identifying a spoofed point of sale device for consumers. As a result, there is an inability for a consumer to identify if a point of sale device is genuine or not until the results of the fraud become apparent on statements or alerts, that is until after the transaction is completed and it is too late. Thus, there is a need for a technological improvement to enable the verification of authenticity of a point of sale device.

SUMMARY

The present disclosure provides a description of systems and methods for verifying the authenticity of a point of sale prior to the initiation of a payment transaction using unique merchant-specific data and blockchain registration. Authorized point of sale devices are registered with a processing system prior to use. The processing system collects merchant-specific data for the authorized point of sale devices, which is then stored in a permissioned blockchain. When a consumer wants to conduct a payment transaction, they use their personal mobile communication device to read merchant-specific data from the point of sale device. The mobile communication device checks the blockchain (directly or through the processing system) to identify if the read merchant-specific data matches a verified, authentic point of sale device as stored in the blockchain. If no match is found, the point of sale device cannot be considered authentic, and no transaction occurs. If a match is found, the point of sale device is considered to be authentic, and the mobile communication device may transmit payment credentials to the point of sale device for use in the payment transaction. The result is that a consumer can be quickly assured of the authenticity of a point of sale device, where the use of a blockchain to store data only for registered merchants ensures that no spoofed point of sale devices can be used or pass the authentication process.

A method for verifying the authenticity of a point of sale prior to the initiation of a payment transaction using unique merchant-specific data and blockchain registration includes: receiving, by an input device interfaced with a mobile communication device, identification data from a point of sale device; receiving, by a receiver of the mobile communication device, data comprising a permissioned blockchain, the data including a plurality of blockchain data values, each data value including at least a set of merchant data; verifying, by a processing device of the mobile communication device, the point of sale device by identifying, in the plurality of blockchain data values, a set of merchant data that matches the received identification data; and outputting, by an output device interfaced with the mobile communication device, a notification to a user of the mobile communication device if verification of the point of sale device fails, or transmitting, by a transmitter of the mobile communication device, payment credentials stored in the mobile communication device to the point of sale device if verification of the point of sale device is successful.

A system for verifying the authenticity of a point of sale prior to the initiation of a payment transaction using unique merchant-specific data and blockchain registration includes: a point of sale device; an input device interfaced with a mobile communication device configured to receive identification data from the point of sale device; a receiver of the mobile communication device configured to receive data comprising a permissioned blockchain, the data including a plurality of blockchain data values, each data value including at least a set of merchant data; a processing device of the mobile communication device configured to verify the point of sale device by identifying, in the plurality of blockchain data values, a set of merchant data that matches the received identification data; an output device interfaced with the mobile communication device configured to output a notification to a user of the mobile communication device if verification of the point of sale device fails; and a transmitter of the mobile communication device configured to transmit payment credentials stored in the mobile communication device to the point of sale device if verification of the point of sale device is successful.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for verifying authenticity of point of sale devices using blockchain in accordance with exemplary embodiments.

FIG. 2 is a block diagram illustrating the mobile communication device of the system of FIG. 1 for verifying authenticity of point of sale devices in accordance with exemplary embodiments.

FIG. 3 is a flow diagram illustrating a process for verifying authenticity of a point of sale device in the system of FIG. 1 in accordance with exemplary embodiments.

FIG. 4 is a flow chart illustrating an exemplary method for verifying the authenticity of a point of sale prior to initiation of a payment transaction using unique merchant-specific data and blockchain registration in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A shared ledger of all transactions of a blockchain-based digital asset, such as a cryptographic currency. One or more computing devices may comprise a blockchain network, each of which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and an asset amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Verifying Authenticity of a Point of Sale Device

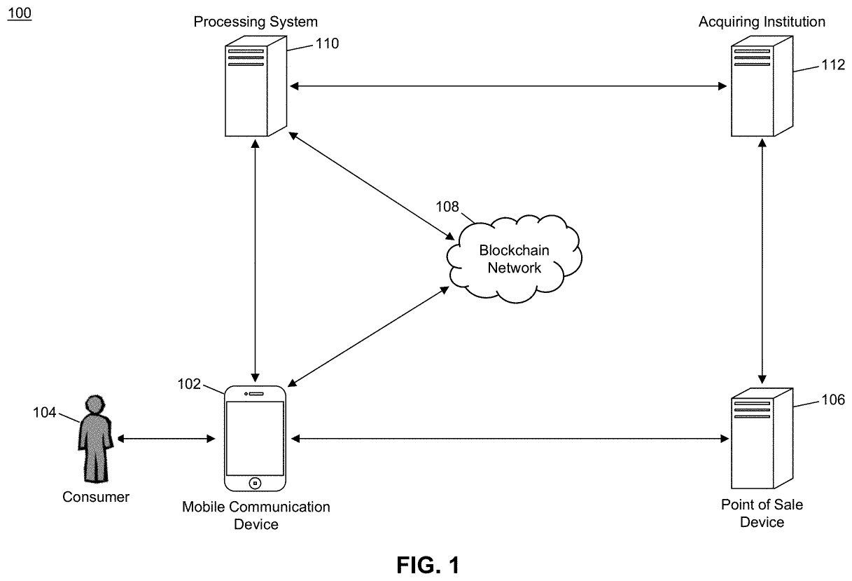

FIG. 1 illustrates a system 100 for verifying the authenticity of a point of sale device 106 using merchant-specific data that is registered and stored in a permissioned blockchain.

The system 100 may include a mobile communication device 102. The mobile communication device 102, discussed in more detail below, may be any type of device suitable for performing the functions discussed herein, such as a specially configured cellular phone, smart phone, smart watch, laptop computer, notebook computer, wearable computing device, etc. The mobile communication device 102 may be possessed by a consumer 104 and used to verify the authenticity of the point of sale device 106 through the use of a permissioned blockchain. The mobile communication device 102 may be further configured to store payment credentials. The payment credentials may be associated with a transaction account and may be comprised of data used in the processing of a payment transaction to ensure that the payment transaction is funded by the associated transaction account. Payment credentials may include, for instance, a primary account number, name, security code, expiration date, one or more payment cryptograms, an application transaction counter, digital signature, digital token, transaction indices, output addresses, etc.

In the system 100, the point of sale device 106 may be registered for storage in a blockchain associated with a blockchain network 108. The point of sale device 106 may be registered directly, or through an associated entity such as a merchant operating the point of sale device 106 or an acquiring institution 112, such as a financial institution that issues a transaction account used for receiving funds in payment transactions initiated by the point of sale device 106. As part of the registration of the point of sale device 106, merchant-specific data that is unique to the point of sale device 106 may be provided to a node in the blockchain network 108. The merchant-specific data may be any data that is uniquely associated to the point of sale device 106, such as a registration number, serial number, media access control address, internet protocol address, etc. In some cases, the merchant-specific data may include a merchant identifier, acquirer identifier, or other data. In some instances, the merchant-specific data may comprise multiple data values that, when taken alone, may not be unique, but, when considered together, may be a combination unique to the point of sale device 106, such as may include a geographic location, merchant name, etc.

The merchant-specific data may be provided to a node in the blockchain network 108. In some embodiments, the system 100 may include a processing system 110. In such embodiments, the point of sale device 106 may be registered through the processing system 110, which may communicate the merchant-specific data to a node in the blockchain network 108. In some cases, the processing system 110 may be a node in the blockchain network 108. In the system 100, the acquiring institution 112 (e.g., if applicable) or point of sale device 106 may register the point of sale device 106 by providing the merchant-specific data to the processing system 110 or blockchain node, as applicable. In some cases, the processing system 110 or node may only accept registration data for a new point of sale device 106 from a trusted entity. For example, acquiring institutions 112 may be required to be trusted entities before any merchant-specific data will be accepted. Trust may be acquired through any suitable authentication process, such as through the conducting of test payment transactions.

The merchant-specific data may be provided to a node in the blockchain network 108 for addition to a blockchain associated therewith. The blockchain network 108 may be comprised of a plurality of nodes, which may include the processing system 110 as a node thereof. Each node may be a computing system that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network prior to the generation and addition of a new block to the blockchain in order for the change to be made permanent. Computational and communication limitations may make such a modification exceedingly difficult, if not impossible, thus rendering the blockchain immutable.

Each blockchain data value may correspond to registration of a point of sale device 106. A blockchain data value may include at least the merchant-specific data associated with the registered point of sale device 106. In some cases, a blockchain data value may include additional information, such as data associated with the acquiring institution 112 that registered the point of sale device 106. For instance, the acquiring institution 112 (e.g., or point of sale device 106, as applicable), may digitally sign the registration of the merchant-specific data using a private key of a cryptographic key pair associated with the acquiring institution 112. In an exemplary embodiment, the blockchain may be a permissioned blockchain, such that only pre-authorized nodes and computing devices may contribute data to be stored in the blockchain. In some cases, only authorized nodes and computing devices, such as the mobile communication device 102, may be allowed to view data stored in the blockchain.

As part of the registration of a point of sale device 106 in the permissioned blockchain, the merchant-specific data may be stored in or otherwise affixed to the point of sale device 106. For instance, a near field communication (NFC) tag may be affixed to the point of sale device 106 that is configured to store and transmit the merchant-specific data. In one such instance, the point of sale device 106 may operate as the NFC tag itself. In another example, a sticker with a machine-readable code (e.g., bar code, quick response (QR) code, etc.) encoded with the merchant-specific data printed thereon may be affixed to the point of sale device 106. In yet another example, the merchant-specific data may be stored in a memory of the point of sale device 106. In another example, the merchant-specific data may be physically printed or displayed on the point of sale device 106.

In the system 100, when the consumer 104 approaches the point of sale device 106 to participate in a payment transaction, the consumer 104 may use the mobile communication device 102 to verify the authenticity of the point of sale device 106. As part of the verification process, the mobile communication device 102 may obtain the merchant-specific data from the point of sale device 106. Obtaining of the merchant-specific data may be performed based on how the merchant-specific data is stored in or on the point of sale device 106. For example, the merchant-specific data may be manually entered into the mobile communication device 102 by the consumer 104 viewing printed merchant-specific data, it may be received by a receiver of the mobile communication device 102 using near field communication or other communication method, or may be decoded from a machine-readable code read by an optical imaging device interfaced with the mobile communication device 102.

Once the merchant-specific data is obtained, the mobile communication device 102 may verify the authenticity of the point of sale device 106 using the merchant-specific data. In one embodiment, the mobile communication device 102 may perform the verification directly. In another embodiment, the mobile communication device 102 may request verification through the processing system 110. Verification may be performed by checking the blockchain data values stored in the blockchain for an occurrence of the merchant-specific data read from the point of sale device 106. If there is a blockchain data value that includes the merchant-specific data, which means that the point of sale device 106 was registered by an authorized entity, then the verification may be considered a success. If there is no such blockchain data value, then the verification may fail and the point of sale device 106 considered inauthentic. If the verification fails, then the mobile communication device 102 may prevent the transmission of payment credentials, and may, in some cases, display a notification to the consumer 104 that the verification failed.

If the verification is successful, then the consumer 104 may proceed with a payment transaction with the point of sale device 106. In some cases, the mobile communication device 102 may electronically transmit the payment credentials stored therein to the point of sale device 106 upon successful verification. The payment credentials may be transmitted using any suitable method, such as any of the methods used for collection of the merchant-specific data by the mobile communication device 102 as discussed above. In other cases, the consumer 104 may provide payment credentials to the point of sale device 106 using any suitable method, such as the providing of a physical payment card used to convey the payment credentials to the point of sale device 106. Once the point of sale device 106 has obtained the payment credentials, then the point of sale device 106 may initiate a payment transaction that is to be funded by the transaction account associated with the payment credentials.

In some embodiments, the blockchain may be used to store updates regarding point of sale devices 106. For instance, if a point of sale device 106 is no longer to be used, a new blockchain data value may be stored in the blockchain that indicates that the point of sale device 106 may no longer be considered authentic. In such an instance, when the processing system 110 or mobile communication device 102 identifies the merchant-specific data in a blockchain data value, the blockchain data value may be checked for any such indication. Other adjustments to status may also be stored in the blockchain, such as temporary breaks in transactions (e.g., for updating, system maintenance, etc.), limits on the types of transactions that the point of sale device 106 may be used for, etc.

The methods and systems discussed herein enable a consumer 104 to be quickly and easily assured of the authenticity of a point of sale device 106. The use of a permissioned blockchain ensures that only authorized point of sale devices 106 may be used, whether the immutable and distributed nature of the blockchain guarantees that no tampering may occur. Comparing stored merchant-specific data with merchant-specific data obtained directly from the point of sale device 106 can ensure that spoofed devices cannot be used, providing consumers 104 with piece of mind and protecting consumers 104 against fraud. In cases where mobile communication devices 102 are specially configured to only transmit payment credentials following successful verification of the authenticity of the point of sale device 106 may result in increased security in the mobile communication device 102, providing a technical improvement over traditional mobile communication devices 102 in terms of data security.

### Mobile Communication Device

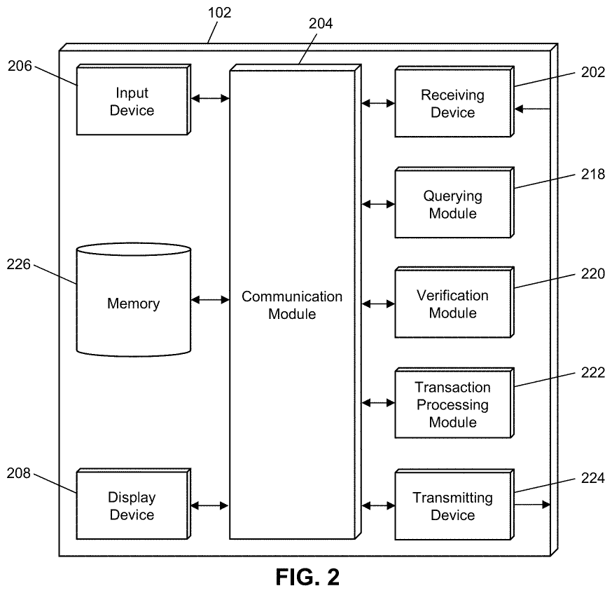

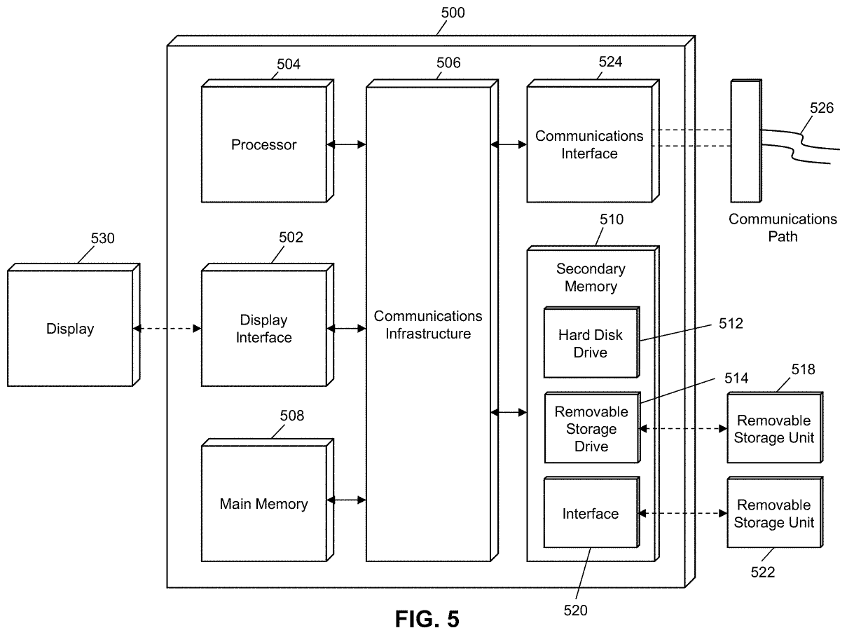

FIG. 2 illustrates an embodiment of a mobile communication device 102 in the system 100. It will be apparent to persons having skill in the relevant art that the embodiment of the mobile communication device 102 illustrated in FIG. 2 is provided as illustration only and may not be exhaustive to all possible configurations of the mobile communication device 102 suitable for performing the functions as discussed herein. For example, the computer system 500 illustrated in FIG. 5 and discussed in more detail below may be a suitable configuration of the mobile communication device 102.

The mobile communication device 102 may include a receiving device 202. The receiving device 202 may be configured to receive data over one or more networks via one or more network protocols. In some instances, the receiving device 202 may be configured to receive data from point of sale devices 106, blockchain networks 108, processing systems 100, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by point of sale devices 106 that are superimposed or otherwise encoded with merchant-specific data. The receiving device 202 may also be configured to receive data signals electronically transmitted by nodes in a blockchain network 108 and/or the processing system 110 that are superimposed or otherwise encoded with blockchain data values and/or verification results for verification of the authenticity of the point of sale device 106.

The mobile communication device 102 may also include a communication module 204. The communication module 204 may be configured to transmit data between modules, engines, databases, memories, and other components of the mobile communication device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the mobile communication device 102 and external components of the mobile communication device 102, such as externally connected databases, display devices, input devices, etc. The mobile communication device 102 may also include a processing device. The processing device may be configured to perform the functions of the mobile communication device 102 discussed herein as will be apparent to persons having skill in the relevant art. In some embodiments, the processing device may include and/or be comprised of a plurality of engines and/or modules specially configured to perform one or more functions of the processing device, such as a querying module 218, verification module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The mobile communication device 102 may also include or be otherwise interfaced with one or more input devices 206. The input devices 206 may be internal to the mobile communication device 102 or external to the mobile communication device 102 and connected thereto via one or more connections (e.g., wired or wireless) for the transmission of data to and/or from. The input devices 206 may be configured to receive input from a user of the mobile communication device 102, which may be provided to another module or engine of the mobile communication device 102 (e.g., via the communication module 204) for processing accordingly. Input devices 206 may include any type of input device suitable for receiving input for the performing of the functions discussed herein, such as a keyboard, mouse, click wheel, scroll wheel, microphone, touch screen, track pad, camera, optical imager, etc. The input device 206 may be configured to, for example, receive merchant-specific data from the point of sale device 106, such as by decoding a machine-readable code displayed thereon.

The mobile communication device 102 may also include or be otherwise interfaced with a display device 208. The display device 208 may be internal to the mobile communication device 102 or external to the mobile communication device 102 and connected thereto via one or more connections (e.g., wired or wireless) for the transmission of data to and/or from. The display device 208 may be configured to display data to a user of the mobile communication device 102. The display device 208 may be any type of display suitable for displaying data as part of the functions discussed herein, such as a liquid crystal display, light emitting diode display, thin film transistor display, capacitive touch display, cathode ray tube display, light projection display, etc. In some instances, the mobile communication device 102 may include multiple display devices 208. The display device 208 may be configured to, for example, display merchant-specific data, notifications regarding authenticity or lack thereof of a point of sale device 106, etc.

The mobile communication device 102 may include a querying module 218. The querying module 218 may be configured to execute queries on databases to identify information. The querying module 218 may receive one or more data values or query strings, and may execute a query string based thereon on an indicated database, such as a memory 226, to identify information stored therein. The querying module 218 may then output the identified information to an appropriate engine or module of the mobile communication device 102 as necessary. The querying module 218 may, for example, execute a query on the memory 226 of the mobile communication device 102 to read payment credentials stored therein for use in a payment transaction.

The mobile communication device 102 may also include a verification module 220. The verification module 220 may be configured to perform verifications for the mobile communication device 102 as part of the functions discussed herein. The verification module 220 may receiving instructions as input, may perform a verification as instructed, and may output a result of the verification to another module or engine of the mobile communication device 102. In some cases, data to be used in the verification may be included in the input. In some instances, the verification module 220 may be configured to identify data for use in the verification, such as by instructing the querying module 218 to perform one or more queries for data. The verification module 220 may, for example, be configured to verify the authenticity of a point of sale device 106 by verifying that merchant-specific data received by the mobile communication device 102 matches merchant-specific data stored in the permissioned blockchain.

The mobile communication device 102 may also include a transaction processing module 222. The transaction processing module 222 may be configured to perform functions related to the processing of payment transactions for the mobile communication device 102. Such functions may include, for instance, the storage of payment credentials, the generation of payment cryptograms, the validation of personal identification numbers, the authentication of a user and/or device, etc.

The mobile communication device 102 may also include a transmitting device 224. The transmitting device 224 may be configured to transmit data over one or more networks via one or more network protocols. In some instances, the transmitting device 224 may be configured to transmit data to point of sale devices 106, blockchain networks 108, processing systems 110, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to point of sale devices 106 that are superimposed or otherwise encoded with payment credentials or requests for merchant-specific data. The transmitting device 224 may also be configured to electronically transmit data signals to nodes in the blockchain network 108 and processing systems 110, which may be superimposed or otherwise encoded with requests for verification, merchant-specific data, requests for blockchain data values, etc.

The mobile communication device 102 may also include a memory 226. The memory 226 may be configured to store data for use by the mobile communication device 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the mobile communication device 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, blockchain data, communication data for blockchain nodes, communication data for processing systems 110, payment credentials, cryptogram generation algorithms, etc.

### Process for Verifying Authenticity of a Point of Sale Device

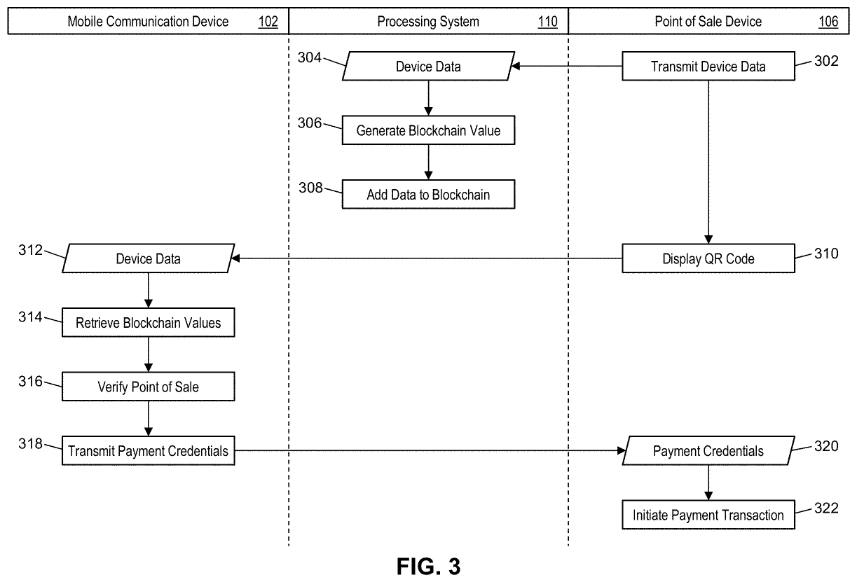

FIG. 3 illustrates an example process for verifying the authenticity of the point of sale device 106 in the system 100 of FIG. 1 using the permissioned blockchain and merchant-specific data.

In step 302, the point of sale device 106 (e.g., or acquiring institution 112 or other associated entity) may transmit merchant-specific data associated with the point of sale device 106 to the processing system 110 (e.g., or other node in the blockchain network 108). In step 304, the processing system 110 may receive the merchant-specific data. In step 306, the processing system 110 may generate a new blockchain data value that includes the merchant-specific data, which may be included in a new block that is generated for addition to the blockchain. In step 308, the new block may be transmitted to other nodes in the blockchain network 108 and then confirmed before being added to the blockchain and distributed across all of the nodes in the blockchain network 108.

In step 310, the point of sale device 106 may display a QR code affixed thereto that is encoded with the merchant-specific data. In step 312, the input device 206 of the mobile communication device 102 may capture an optical image of the QR code displayed on the point of sale device 106 and may decode the merchant-specific data encoded therein. In step 314, the receiving device 202 of the mobile communication device 102 may receive blockchain data values stored in the blockchain, such as by requesting the blockchain data values from the processing system 110 or other node in the blockchain network 108 or by reading the blockchain data values as made available by the blockchain.

In step 316, the verification module 220 of the mobile communication device 102 may verify the authenticity of the point of sale device 106 by comparing the read merchant-specific data to the data included in the received blockchain data values and identifying a match with the merchant-specific data in one of the blockchain data values. In step 318, the transmitting device 224 of the mobile communication device 102 may electronically transmit the payment credentials stored in the memory 226 of the mobile communication device 102 to the point of sale device 106 following the successful verification of the authenticity of the point of sale device 106. In step 320, the point of sale device 106 may receive the payment credentials. In step 322, the point of sale device 106 may initiate a payment transaction that includes use of the payment credentials for funding of the payment transaction by the associated transaction account. Initiation of the payment transaction may include the submission of an authorization request to a payment network via payment rails associated therewith, where the authorization request is a specialty formatted data message formatting according to standards governing the exchange of financial transaction messages, such as the International Organization of Standardization's ISO 8583 or ISO 20022 standards.

### Exemplary Method for Verifying Authenticity of a Point of Sale

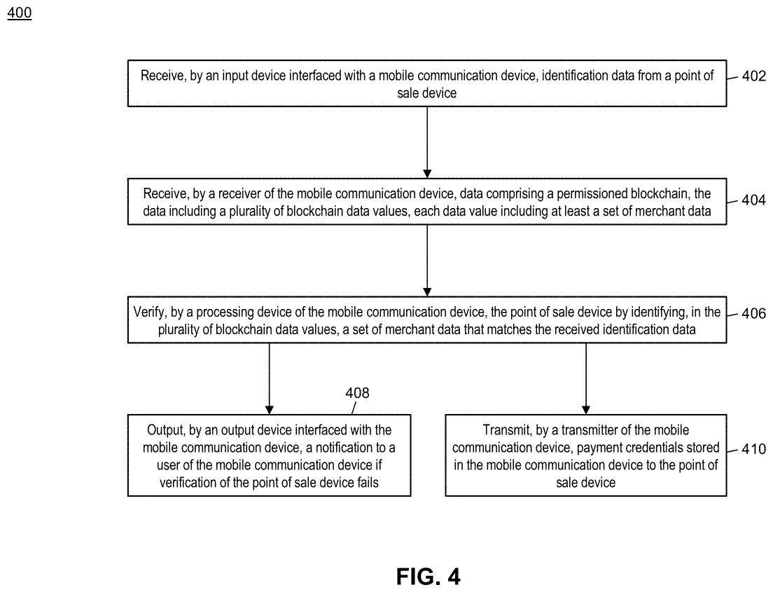

FIG. 4 illustrates a method 400 for the verification of the authenticity of a point of sale device prior to the initiation of a payment transaction using unique merchant-specific data and blockchain registration.

In step 402, identification data may be received by an input device (e.g., input device 206) interfaced with a mobile communication device (e.g., the mobile communication device 102) from a point of sale device (e.g., the point of sale device 106). In step 404, data comprising a permissioned blockchain may be received by a receiver (e.g., the receiving device 202) of the mobile communication device, the data including a plurality of blockchain data values, each data value including at least a set of merchant data. In step 406, the point of sale device may be verified by a processing device (e.g., the verification module 220) of the mobile communication device by identifying, in the plurality of blockchain data values, a set of merchant data that matches the received identification data.

If verification of the point of sale device fails, then, in step 408, a notification may be output by an output device (e.g., the display device 208) of the mobile communication device to a user (e.g., the consumer 104) of the mobile communication device. If the verification of the point of sale device succeeds, then, in step 410, payment credentials stored in the mobile communication device may be transmitted to the point of sale device by a transmitter (e.g., the transmitting device 224) of the mobile communication device.

In one embodiment, the identification data may be received from a point of sale device by reading, by an optical imaging device of the mobile communication device, a machine-readable code physically displayed on the point of sale device encoded with the identification data. In some embodiments, the identification data may be received from the point of sale device using near field communication. In one embodiment, the payment credentials may be transmitted to the point of sale device using near field communication.

In some embodiments, the transmitter of the mobile communication device may be a display device interfaced with the mobile communication device, and transmission of the payment credentials may comprise display of a machine-readable code on the display device encoded with the payment credentials. In one embodiment, the payment credentials may include at least one of: a primary account number, a digital token, and a digital signature. In some embodiments, the identification data may include at least one of: merchant identification number, geographic location, merchant name, device identifier, and media access control address. In one embodiment, the identification data may match a set of merchant data included in a specific blockchain data value of the plurality of blockchain data values, and the specific blockchain data value may be digitally signed by a financial institution that issued a transaction account to a merchant associated with the set of merchant data.

### Computer System Architecture

FIG. 5 illustrates a computer system 500 in which embodiments of the present disclosure, or portions thereof, may be implemented as computer-readable code. For example, the mobile communication device 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for verifying the authenticity of a point of sale prior to initiation of a payment transaction using merchant-specific data and blockchain registration. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for verifying the authenticity of a point of sale prior to the initiation of a payment transaction using unique merchant-specific data and blockchain registration, comprising:
receiving, by an input device interfaced with a mobile communication device, identification data from a point of sale device;
receiving, by a receiver of the mobile communication device, data comprising a permissioned blockchain, the data including a plurality of blockchain data values, each data value including at least a set of merchant data;
verifying, by a processing device of the mobile communication device, the point of sale device by identifying, in the plurality of blockchain data values, a set of merchant data that matches the received identification data; and
outputting, by an output device interfaced with the mobile communication device, a notification to a user of the mobile communication device if verification of the point of sale device fails, or
transmitting, by a transmitter of the mobile communication device, payment credentials stored in the mobile communication device to the point of sale device if verification of the point of sale device is successful.

2. The method of claim 1, wherein the identification data is received from a point of sale device by reading, by an optical imaging device of the mobile communication device, a machine-readable code physically displayed on the point of sale device encoded with the identification data.

3. The method of claim 1, wherein the identification data is received from the point of sale device using near field communication.

4. The method of claim 1, the payment credentials are transmitted to the point of sale device using near field communication.

5. The method of claim 1, wherein
the transmitter of the mobile communication device is a display device interfaced with the mobile communication device, and
transmission of the payment credentials comprises display of a machine-readable code on the display device encoded with the payment credentials.

6. The method of claim 1, wherein the payment credentials include at least one of: a primary account number, a digital token, and a digital signature.

7. The method of claim 1, wherein the identification data includes at least one of: merchant identification number, geographic location, merchant name, device identifier, and media access control address.

8. The method of claim 1, wherein
the identification data matches a set of merchant data included in a specific blockchain data value of the plurality of blockchain data values, and
the specific blockchain data value is digitally signed by a financial institution that issued a transaction account to a merchant associated with the set of merchant data.

9. A system for verifying the authenticity of a point of sale prior to the initiation of a payment transaction using unique merchant-specific data and blockchain registration, comprising:
a point of sale device;
an input device interfaced with a mobile communication device configured to receive identification data from the point of sale device;
a receiver of the mobile communication device configured to receive data comprising a permissioned blockchain, the data including a plurality of blockchain data values, each data value including at least a set of merchant data;
a processing device of the mobile communication device configured to verify the point of sale device by identifying, in the plurality of blockchain data values, a set of merchant data that matches the received identification data;
an output device interfaced with the mobile communication device configured to output a notification to a user of the mobile communication device if verification of the point of sale device fails; and
a transmitter of the mobile communication device configured to transmit payment credentials stored in the mobile communication device to the point of sale device if verification of the point of sale device is successful.

10. The system of claim 9, wherein the identification data is received from a point of sale device by reading, by an optical imaging device of the mobile communication device, a machine-readable code physically displayed on the point of sale device encoded with the identification data.

11. The system of claim 9, wherein the identification data is received from the point of sale device using near field communication.

12. The system of claim 9, the payment credentials are transmitted to the point of sale device using near field communication.

13. The system of claim 9, wherein
the transmitter of the mobile communication device is a display device interfaced with the mobile communication device, and
transmission of the payment credentials comprises display of a machine-readable code on the display device encoded with the payment credentials.

14. The system of claim 9, wherein the payment credentials include at least one of: a primary account number, a digital token, and a digital signature.

15. The system of claim 9, wherein the identification data includes at least one of: merchant identification number, geographic location, merchant name, device identifier, and media access control address.

16. The system of claim 9, wherein
the identification data matches a set of merchant data included in a specific blockchain data value of the plurality of blockchain data values, and
the specific blockchain data value is digitally signed by a financial institution that issued a transaction account to a merchant associated with the set of merchant data.
